(19) United States
(12) Patent Application Publication
(10) Pub. No.: US 2018/0275346 A1
(43) Pub. Date: Sep. 27, 2018

(54) Compact structure of integrated WDM device

(71) Applicants: Jinghui Li, Sierra Madre, CA (US); Wen Lu, Shenzhen (CN); Cheng Jin, Highland Mills, NY (US); Yuan Liu, Shenzhen (CN); Chengpeng Zhang, Shenzhen (CN); Qiang Zhou, Shenzhen (CN)

(72) Inventors: Jinghui Li, Sierra Madre, CA (US); Wen Lu, Shenzhen (CN); Cheng Jin, Highland Mills, NY (US); Yuan Liu, Shenzhen (CN); Chengpeng Zhang, Shenzhen (CN); Qiang Zhou, Shenzhen (CN)

(21) Appl. No.: 15/731,480

(22) Filed: Jun. 16, 2017

Related U.S. Application Data
(60) Provisional application No. 62/601,488, filed on Mar. 24, 2017.

(51) Int. Cl. G02B 6/293; G02B 27/10; G02B 27/14

(52) U.S. Cl. CPC G02B 6/29367; G02B 27/142; G02B 27/1006; G02B 6/2938

(57) ABSTRACT

Embodiments of present invention provide a WDM device which includes a first element having a first right surface and a first top surface; and a second element having a second left surface and a second bottom surface, wherein the second bottom surface is bonded together with the first top surface and the first right surface is coated with a WDM filtering coating which is adapted to, upon incident of an optical signal having at least a first and a second wavelength, cause the first wavelength of the optical signal to exit the first element at the first right surface, and cause rest of the optical signal to be reflected back into the first element, pass through the first top surface and the second bottom surface, and enter the second element. A method of making the WDM devices is also provided.

### CROSS REFERENCE TO RELATED APPLICATION

The present application claims benefit of priority to a provisional U.S. patent application Ser. No. 62/601,488, filed Mar. 24, 2017, the content of which is incorporated herein by reference in its entirety.

### FIELD OF THE INVENTION

The present application relates generally to optical integrated devices, and more particularly to a WDM device and method of making the same.

### BACKGROUND

Optical signal communication is one of the most important communication methods in high speed data connection in the field of, e.g., Telecom, Datacom (including data centers), CATV, medical image transmission, and potential video signal transmission in flights, boats and cars. Transmitters using high speed lasers, such as DFB (distributed feedback) lasers and/or VCSEL (vertical cavity surface emitting lasers), and receivers using high speed photo detectors, such as PIN (p-i-n junction photo-diode) and/or APD (avalanche photo-diode), are two of the key enabling components in optical signal communication. Usually, transmitters and receivers are integrated respectively into sub-assembly packages such as TOSA (transmitter optical sub-assembly) and ROSA (receiver optical sub-assembly) packages.

Optical signal communication employs digital signal modulation. However, it has been a constant challenge to keep increasing the modulation speed of lasers and photo detectors. For example, beyond certain data rate, such as 25Gb/s or 50Gb/s, due to RF (radio frequency) signal and IC (integrated circuits) process related restrains, it becomes unpractical, at least financially, to increase the data rate solely relying on the speed of signal modulation. On the other hand, WDM (wavelength division multiplexing) technology becomes a very cost effective approach to increase the data rate by multiplexing several wavelengths (colors) of modulated light signals together inside TOSA and ROSA packages, effectively doubling, tripling, or even multiplying the data rate depending on the number of wavelengths being multiplexed. WDM devices, such as WDM filters and combiners, are some of the key elements in WDM technology and are found commonly used in TOSA and ROSA packages.

FIG. 1 is a simplified illustration of a two-wavelength WDM device as is currently known in the art. In the example illustrated in FIG. 1, WDM filter 100 includes two miniature optical filters 110 and 120, pre-fabricated and pre-assembled, which are separately attached to a common optical base 101 through epoxy or optical contact bonding by an assembly machine or human assembler. Each optical filter 110 and 120 has a substrate and, at its bottom surface, is coated with either coating 1 or coating 2 that are optically different in order to transmit and/or reflect optical signals of different wavelengths. The top surfaces of each optical filter 110 and 120 are also coated with AR (anti-reflection) coating in order to permit exiting of optical signals. Moreover, at the bottom of the optical base 101, AR coating has to be carefully applied only to the input beam area while HR (high reflection) coating or mirror coating has to be applied to the rest areas in order to properly guide optical beam along paths inside the optical base 101.

The current approach of making WDM device 100, by attaching each optical filter (e.g., 110 and 120) to a common optical base (e.g., 101), is a time consuming, labor intensive, and low efficiency process, even with the help of an automatic machine assembly. The surfaces (where coatings are applied) of these optical filters often become curled when the filters are sliced to a very thin thickness (typically around 0.8mm, 0.6mm or even thinner) due to the stress release of the filters. The curled surfaces of filters could potentially cause misalignment of optical beams from different optical filters (e.g., 110 and 120) travelling inside the WDM device (e.g., 100) and result in high coupling loss when the WDM device is used in TOSA and/or ROSA packages.

As being illustrated in FIG. 1, when being used as a de-multiplexer in a ROSA, WDM device 100 may receive an optical beam (known as a WDM optical signal) which may include a first and a second optical wavelengths λ1 (Lambda 1) and λ2 (Lambda 2). The optical beam may

JL201701 2/26 pass through the AR coating area of the optical base 101 from the bottom. The λ1 optical signal will exit optical base 101 at an interface with optical filter 110, pass through the coated bottom and top surfaces of optical filter 110, and finally exit WDM device 100. In the meantime, the λ2 optical signal will be reflected by the coated bottom surface of optical filter 110 back into optical base 101, subsequently reflected by the HR or mirror coating of optical base 101, and exit optical base 101 at an interface with optical filter 120, pass through the coated bottom and top surfaces of optical filter 120, and finally exit WDM device 100. By its reciprocal property, WDM device 100 may also be used in a reverse direction as a multiplexer to combine two optical signals of wavelengths λ1 and λ2 into a WDM optical signal, as may be understood by a person skilled in the art.

### SUMMARY

A compact structure of integrated WDM (wavelength division multiplexing) device is provided whose simplified manufacture and assembly process provides improved efficiency over currently existing technology. More specifically, the method includes first forming multiple optical filter-base sheet elements that have coatings made directly onto a number of optical bases and that may provide same or different optical filtering functions. The multiple filter-base sheet elements are subsequently glued or bonded together using epoxy, adhesive agent, or optical contact bonding in an optical bonding process to form an optical assembly block. Even though the optical assembly block by itself may be able to provide wavelength multiplexing and/or de-multiplexing functions, it is often made to have a sufficient length and thus may be sliced (along its length) into multiple thin pieces of WDM devices, through, e.g., a machine-based or laser-based automatic slicing/dicing process. Each of the WDM devices so sliced from the optical assembly block may provide the exact same wavelength multiplexing or de-multiplexing functions. The above process provides a much higher efficiency and overall throughput, in comparison with current manual or machine-based assembly process which attaches individual filters to a common base, in producing WDM devices used in TOSA/ROSA for optical high speed data connection and other applications in different fields.

According to one embodiment, a WDM device includes a first element having a first right surface and a first top surface; and a second element having a second left surface and a second bottom surface, wherein the second bottom surface of the second element is bonded together with the first top surface of the first element and the first right surface of the first element is coated with a WDM filtering coating, and wherein the WDM filtering coating of the first right surface is adapted to, upon incident of an optical signal having at least a first wavelength and one or more of a second, a third, and a fourth wavelength, cause the first wavelength of the optical signal to exit the first element at the first right surface, and cause rest of the optical signal to be reflected back into the first element, pass through the first top surface of the first element and the second bottom surface of the second element, and enter the second element.

In one embodiment, the second element further includes a second right surface coated with a WDM filtering coating, the WDM filtering coating of the second right surface is adapted to, upon incident of the optical signal, cause the third wavelength of the optical signal to exit the second element at the second right surface.

In another embodiment, the WDM device further includes a third element having a third left surface and a third bottom surface, wherein the second element further includes a second top surface, wherein the third bottom surface of the third element is bonded together with the second top surface of the second element, and wherein the WDM filtering coating of the second right surface is further adapted to cause rest of the optical signal to be reflected back into the second element, pass through the second top surface of the second element and the third bottom surface of the third element, and enter the third element.

In one embodiment, the third left surface of the third element is coated with a WDM filtering coating, the WDM filtering coating of the third left surface is adapted to, upon incident of the optical signal, cause the fourth wavelength of the optical signal to exit the third element at the third left surface.

In another embodiment, the second left surface of the second element is coated with a WDM filtering coating, the WDM filtering coating of the second left surface is adapted to, upon incident of the optical signal, cause the second wavelength of the optical signal to exit the second element at the second left surface.

In one embodiment, the first element further includes a first left surface coated with an anti-reflective coating; wherein the optical signal enters the first element at the first left surface; and wherein the second element is bonded together with the first element through an adhesive agent or an optical contact bonding process.

According to another embodiment, a WDM device includes a first element having a first left surface, a first right surface, a first top surface, and a first bottom surface; wherein the first top surface and the first bottom surface are substantially planar and extending from the first left surface to the first right surface; and a second element having a second left surface, a second right surface, a second top surface, and a second bottom surface, wherein the second top surface and the second bottom surface are substantially planar and extending from the second left surface to the second right surface, wherein the second bottom surface of the second element is bonded together with the first top surface of the first element; wherein the first right surface of the first element is coated with a first WDM filtering coating; and wherein the second right surface of the second element is coated with a second WDM filtering coating.

According to yet another embodiment, a method of making WDM devices includes preparing a first sheet element having a first top surface and a first bottom surface, a first left surface and a first right surface, and a first length along a length-direction; wherein the first right surface is coated with a first WDM filtering coating; preparing a second sheet element having a second top surface and a second bottom surface, a second left surface and a second right surface, and a second length along the length-direction, wherein the second right surface is coated with a second WDM filtering coating; stacking the second bottom surface of the second sheet element on top of the first top surface of the first sheet element to form an optical assembly block; and slicing the optical assembly block along the length-direction into a plurality of WDM devices such that each of the plurality of WDM devices comprises a piece of the first sheet element attached to a piece of the second sheet element.

### BRIEF DESCRIPTION OF THE DRAWINGS

The present invention will be understood and appreciated more fully from the following detailed description of embodiments of the invention, taken in conjunction with accompanying drawings of which:

FIG. 1 is a simplified illustration of a two-wavelength WDM device as is currently known in the art;

FIG. 2 and FIG. 2(a) are demonstrative illustrations of an integrated structure of a two-wavelength WDM device according to some embodiment of present invention;

FIG. 3 is a demonstrative illustration of an integrated structure of a four-wavelength WDM device according to an embodiment of present invention;

FIG. 4 is a demonstrative illustration of an integrated structure of a four-wavelength WDM device according to another embodiment of present invention;

FIG. 5 is a demonstrative illustration of an integrated structure of a four-wavelength WDM device according to yet another embodiment of present invention;

FIG. 6 is a demonstrative illustration of an integrated structure of a four-wavelength WDM device according to a further embodiment of present invention;

FIG. 7 is a demonstrative illustration of an integrated structure of an eight-wavelength WDM device according to an embodiment of present invention;

FIG. 8 is a demonstrative illustration of examples of optical filter-base sheet elements according to embodiments of present invention;

FIG. 9 is a demonstrative illustration of an example of optical assembly block made of the filter-base sheet elements illustrated in FIG. 8; and

FIG. 10 is a demonstrative illustration of an example of a plurality of WDM devices made from the optical assembly block illustrated in FIG. 9.

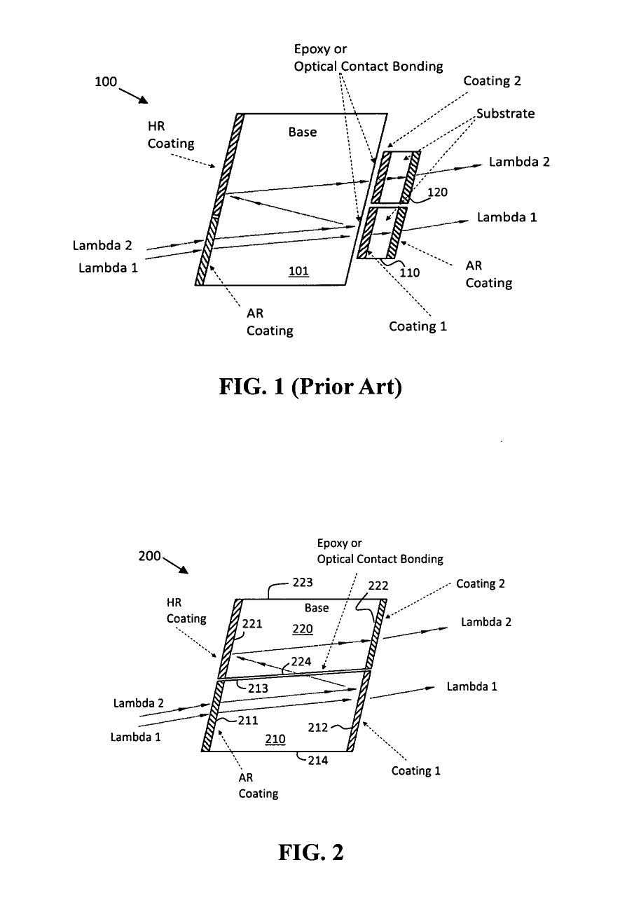

It will be appreciated that for simplicity and clarity purpose, elements shown in the drawings have not necessarily been drawn to scale. Further, in various functional block diagrams, two connected devices and/or elements may not necessarily be illustrated to be connected. In some other instances, grouping of certain elements in a functional block diagram may be solely for the purpose of description and may not necessarily imply that they are in a single physical entity or they are embodied in a single physical entity.

### DETAILED DESCRIPTION OF PREFERRED EMBODIMENTS

It is clear that there is an urgent need to provide a cost effective way of manufacturing WDM devices that are used to combine (multiplex) multiple optical signals of different wavelengths into a single WDM stream of optical signal at a TOSA, and to divide (de-multiplex) a single WDM stream of optical signal into multiple optical signals based on their different wavelengths at a ROSA.

Embodiments of present invention provide a method of making compact structure of integrated WDM device with improved efficiency and WDM devices made by the method. More specifically, the method includes making multiple optical filters that are each made of an optical base which is directly coated, and coated differently among the multiple optical filters, to work as an optical filter-base sheet element. The multiple filter-base sheet elements are subsequently glued or bonded together in an optical bonding process to achieve optical wavelength division multiplexing or de-multiplexing functions by the virtue that different optical coatings are applied to surfaces of different filter base elements. The optical assembly block formed by the multiple filter-base sheet elements may be further sliced by machines or using lasers in high efficiency into many pieces of identical WDM devices such as WDM filters. The WDM filters may be used in TOSA and/or ROSA packages for high speed Datacom optical interconnections or other applications in different fields.

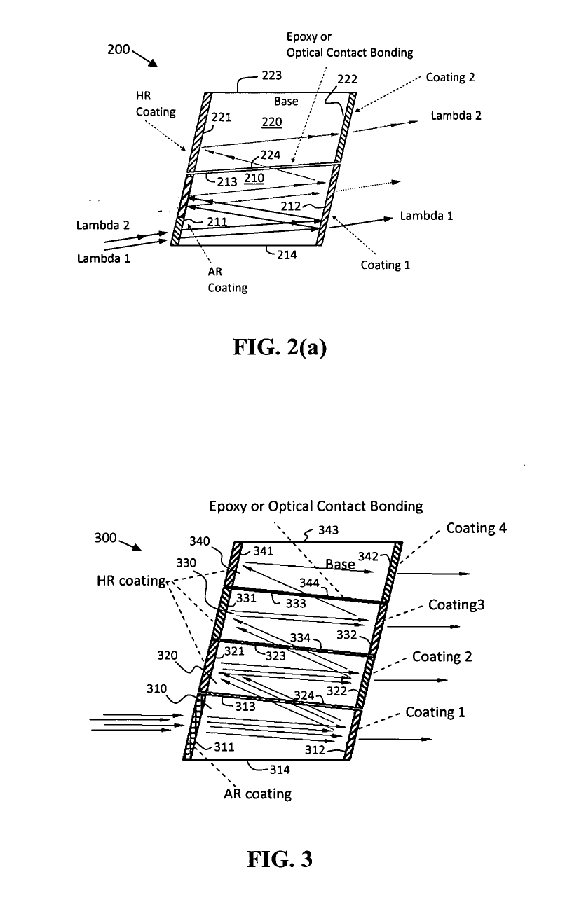

FIG. 2 is a demonstrative illustration of an integrated structure of a two-wavelength WDM device according to one embodiment of present invention. In FIG. 2, WDM device 200 is illustrated in a cross-sectional view which, by various arrows, shows how a WDM optical signal (of multiple wavelengths) may propagate through the device. The same notion may be applied to FIGS. 2(a), 3, 4, 5, 6, and 7 which are illustrative cross-sectional views of various WDM devices according other embodiments of present invention. It is commonly understood that WDM device 200 and others as being discussed herein has a thickness (sometimes referred to as a length) in a direction perpendicular to this paper.

WDM device 200 may include a first element 210 having a first left surface 211, a first right surface 212, a first top surface 213, and a first bottom surface 214. As used herein, the terms “left”, “right”, “top”, and “bottom” are generally used relative to the orientation of the drawings being illustrated, and these references may change depending on different orientation of the referred drawings. For example, should the drawing of WDM device 200 in FIG. 2 be counter-clock-wise rotated 90 degrees, the first left surface may be referred to instead as a first bottom surface; the first right surface may be referred to instead as a first top surface; the first top surface may be referred to instead as a first left surface; and the first bottom surface may be referred to instead as a first right surface. Also, the term “surface” is generally used to refer to a surface that is substantially planar, absent being specifically indicated otherwise.

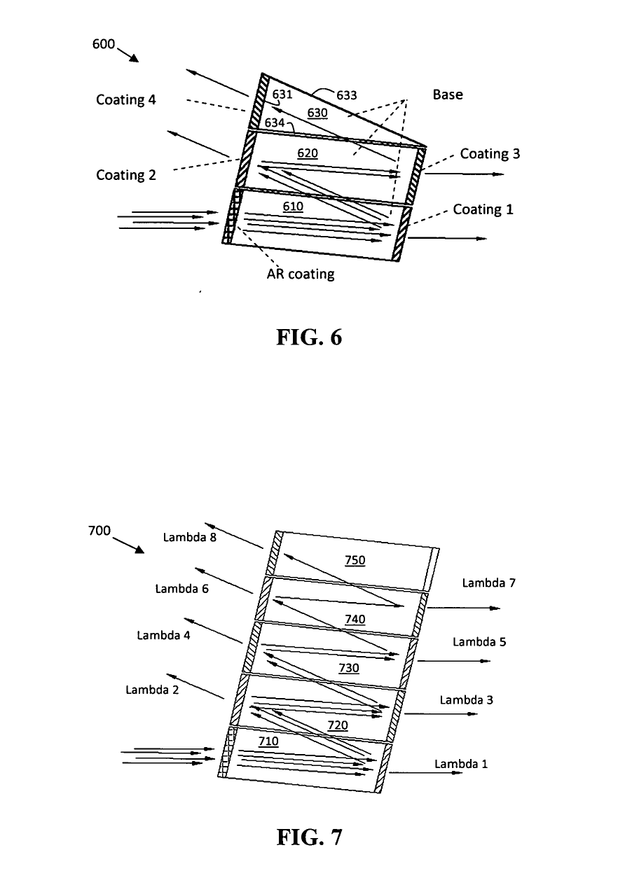

Referring back to FIG. 2, wherein first top surface 213 and first bottom surface 214 may extend from first left surface 211 to first right surface 212. In one or more embodiments, first element 210 may be in a rectangular shape, a trapezoidal shape, a parallelogram shape, or any other four-sided shapes. However, embodiments of present invention are not limited in this respect and first element 210 may be in other shapes modified from the above four-sided shapes while proper optical signal paths when passing through the device, as being described below in more details, are still provided. For example, first element 210 may be in a triangular shape with first right surface 212, first top surface 213, and another surface in-between (not shown). WDM device 200 may further include a second element 220 having a second left surface 221, a second right surface 222, a second top surface 223, and a second bottom surface 224, wherein second top surface 223 and second bottom surface 224 may extend from second left surface 221 to second right surface 222. In one or more embodiments, second element 220 may be in a rectangular shape, in a trapezoidal shape, in a parallelogram shape, or any other suitable shapes modified from the above that still provide proper optical signal paths as being described below in more details. For example, in one embodiment, second element 220 may be in a triangular shape with second left surface 221, second bottom surface 224, and another surface in-between (not shown), similar to third element 630 as is illustrated in FIG. 6.

In one embodiment, first left surface 211 of first element 210 may be substantially aligned with and coplanar with second left surface 221 of second element 220. In another embodiment, first right surface 212 of first element 210 may be substantially aligned with and coplanar with second right surface 222 of second element 220.

First left surface 211 of first element 210 may be coated with an AR (anti-reflective) coating that allows most of an incident WDM optical signal, of a pre-determined range or number of wavelengths, to enter first element 210 with a minimal insertion loss. The WDM optical signal may pass through first left surface 211 and propagate inside first element 210 toward first right surface 212. First right surface 212 may be coated with a WDM filtering coating, which is reflective to most of the WDM optical signal except a first optical signal of a first wavelength λ1 (Lambda 1). The WDM filtering coating may reflect the most of the WDM optical signal back toward second left surface 221 of second element 220. In the meantime, first right surface 212 may allow the first optical signal of the first wavelength to pass through and exit first element 210.

Second element 220 may be bonded together with first element 210, via second bottom surface 224 of second element 220 and first top surface 213 of first element 210. The bonding may be made through an epoxy, an adhesive agent, or an optical contact bonding process across a substantial portion of second bottom surface 224 and first top surface 213. Reflected remaining WDM optical signal from first right surface 212 may pass through first top surface 213 and second bottom surface 224 to enter second element 220. In one embodiment, second left surface 221 may be coated with an HR (high reflection) coating to reflect the WDM optical signal to propagate toward second right surface 222 inside second element 220. In one embodiment, second right surface 222 of second element 220 may be coated with a WDM filtering coating that is reflective to most of the WDM optical signal except a second optical signal of a second wavelength λ2 (Lambda 2). The WDM filtering coating of second right surface 222 subsequently allows the second optical signal of the second wavelength to pass through and exit second element 220.

In one embodiment, second right surface 222 of second element 220 may be coated with an AR coating, instead of the WDM filtering coating, or may not be coated at all. All optical signals or light arriving at second right surface 222 may exit second element 220. This may particularly be the case when the WDM optical signal incident upon second right surface 222 of second element 220 may include only the second optical signal of the second wavelength.

First element 210 and second element 220 of WDM device 200, as being illustrated in FIG. 2, may be arranged, in terms of their respective sizes, shapes, and various surfaces, such that an WDM optical signal entering first element 210 may be able to follow an optical path to reach first right surface 212, to be reflected by first right surface 212 to propagate to second left surface 221, to be reflected by second left surface 221, and finally reach second right surface 222. In one embodiment, first and second elements 210 and 220 may both preferably be in a rectangular shape or a parallelogram shape of a same size (except being coated differently at their respective left and right surfaces). In another embodiment, first and second elements 210 and 220 may both be in a trapezoidal shape and arranged in a way as is illustrated in FIG. 2, with first left surface 211 being substantially parallel to first right surface 212 and second left surface 221 being substantially parallel to second right surface 222. However, embodiments of present invention are not limited in this respect, and first and second elements 210 and 220 may be in any other suitable four-sided shape or even multi-sided shapes so long as it enables the WDM optical signal to follow the optical path, from first left surface 211 to second right surface 222, as being described above.

In the above description, WDM device 200 may have been described as a WDM filter or de-multiplexer typically found in a ROSA. A person skilled in the art will appreciate that by simply reversing the direction of operation, WDM device 200 may work as a multiplexer or WDM combiner typically found in a TOSA. For example, a first optical signal of a first wavelength and a second optical signal of a second wavelength may be launched into first right surface 212 and second right surface 222, respectively, to obtain a combined WDM optical signal exiting first left surface 211 of first element 210. The same operating principle may be applied to the various WDM devices being described hereinafter.

FIG. 2(a) is a demonstrative illustration of an integrated structure of a two-wavelength WDM device according to another embodiment of present invention. WDM device 200 in FIG. 2(a) is mostly the same as WDM device 200 in FIG. 2, except first left surface 211 has a lower portion being coated with an AR coating and an upper portion being coated with an HR coating. The different coatings of first left surface 211 allows WDM optical signal to propagate back and forth multiple times inside first element 210 before entering second element 220. Multiple reflections inside first element 210 help improve extinction ratio of, in the instant example, second wavelength (Lambda 2) over first wavelength (Lambda 1) of the WDM optical signal getting into second element 220 by filtering out more component of the first wavelength of optical signal. A person skilled in the art will understand that similar multiple reflection practice may be used in different elements of WDM devices according various embodiment of present invention.

FIG. 3 is a demonstrative illustration of an integrated structure of a four-wavelength WDM device according to an embodiment of present invention. As an expansion of the two-wavelength WDM device illustrated in FIG. 2, WDM device 300 in FIG. 3 has a first, a second, a third, and a fourth element 310, 320, 330, and 340 bonded together at their respective top and/or bottom surfaces that form a four-wavelength WDM device. WDM device 300 may work as a WDM filter or de-multiplexer in one direction, or alternatively as a WDM combiner or multiplexer in an opposite direction.

More specifically, WDM device 300 may include first element 310, second element 320, third element 330, and fourth element 340 with a first top surface 313 of first element 310 being bonded together with a second bottom surface 324 of second element 320, a second top surface 323 of second element 320 being bonded together with a third bottom surface 334 of third element 330, and a third top surface 333 of third element 330 being bonded together with a fourth bottom surface 344 of fourth element 340.

First left surface 311 and first right surface 312 of first element 310 may be coated similar to that of first element 210 of WDM device 200 shown in FIG. 2. Second left surface 321 and second right surface 322 of second element 320 may be coated similar to that of second element 220 of WDM device 200. Additionally, both left and right surfaces of third element 330 and fourth element 340 may be coated similar to that of second element 320 except that the WDM filtering coating (coating 3 and coating 4) on the right surfaces 332 and 342 may be made to allow a third optical signal of a third wavelength to pass through third element 330 and a fourth optical signal of a fourth wavelength to pass through fourth element 340, respectively. Similar to what is described above with regard to WDM device 200, fourth right surface 342 of fourth element 340 may be coated with an AR coating or not coated at all should all remaining optical signals are designed to exit fourth element 340 via its fourth right surface 342 as being described below in more details.

Similar to what is described in connection with FIG. 2, reflected WDM optical signal from second right surface 322 may continue to propagate and enter third element 330 via second top surface 323 of second element 320 and third bottom surface 334 of third element 330, subsequently get reflected from third left surface 331 to propagate toward third right surface 332 along an optical path inside third element 330. The WDM filtering coating of third right surface 332 allows a third optical signal of a third wavelength to pass through and exit third element 330, and in the meantime reflects rest of the remaining WDM optical signal back toward fourth left surface 341 of fourth element 340. The HR coating of fourth left surface 341 may reflect the WDM optical signal which then propagates toward fourth right surface 342. A fourth optical signal of the WDM optical signal, with a fourth wavelength, eventually exit fourth right surface 342 of fourth element 340. According to one embodiment, fourth right surface 342 may be coated to allow only the fourth optical signal of the fourth wavelength to exit. However, embodiments of present invention are not limited in this respect. Should the WDM optical signal contains only the fourth optical signal at this stage or it is permissible to let all of the remaining WDM optical signal to exit at this stage, fourth right surface 342 may only be coated with an AR coating in order to improve coupling efficiency. The AR coating may even be omitted should a slightly lower coupling efficiency at fourth right surface 342 be acceptable in order to save cost of applying AR coating to the surface. The AR coating applied to first left surface 311 may be similarly omitted as well for cost saving purpose.

In FIG. 3, WDM 300 is demonstratively illustrated to be made of two parallelogram shape elements (second element 320 and third element 330) and two trapezoidal shape elements (first element 310 and fourth element 340) where first top surface 313 is not in parallel with first bottom surface 314 and fourth top surface 343 is not in parallel with fourth bottom surface 344. However, embodiments of present invention are not limited in this respect. The four elements, being their respective shapes, sizes, and/or positions, may be arranged in such a way so long as an input WDM optical signal entering first left surface 311 of first element 310 may eventually reach fourth right surface 342 of fourth element 340 via an optical path which goes through all of the four elements, once or multiple times, and optical signals of various wavelengths may exit different elements at the properly coated right surfaces.

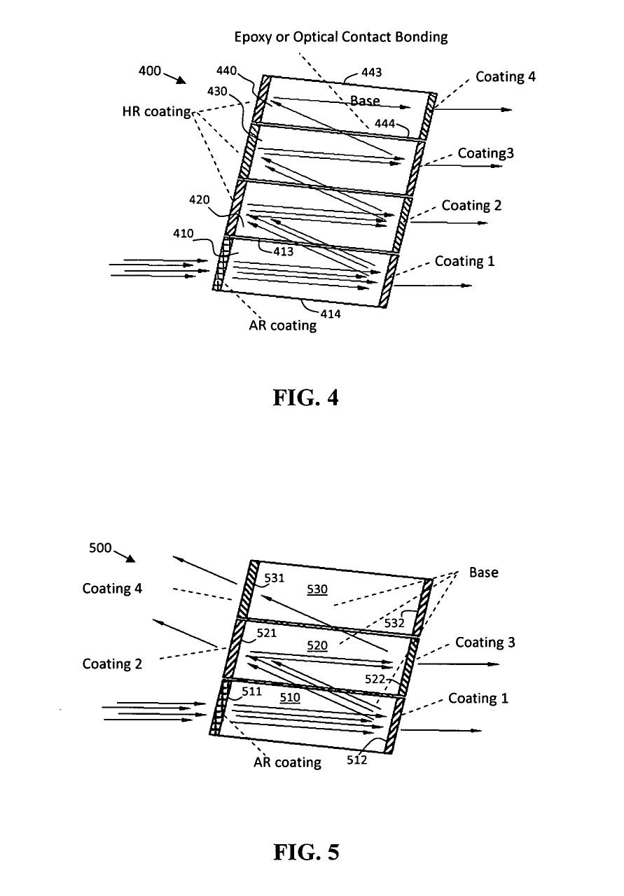

FIG. 4 is a demonstrative illustration of an integrated structure of a four-wavelength WDM device according to another embodiment of present invention. More specifically, WDM device 400, as being illustrated in FIG. 4, may be made of four elements (410, 420, 430, and 440) of substantially same size and same shape (albeit different coatings), all in parallelogram shape. More specifically, comparing with WDM device 300, WDM device 400 has first top surface 413 in parallel with first bottom surface 414 and fourth top surface 443 in parallel with fourth bottom surface 444. Furthermore, although not shown in FIG. 4, all four elements could be in rectangular shape or other shapes as well. Even though not necessary for functionality, using elements of substantially similar shape and size, in particular with parallel top and bottom surfaces, may increase manufacture efficiency as well as provide scalability of making WDM devices with regard to the number of wavelengths supported. For example, when a six or eight-wavelength WDM device is desired, additional elements may be simply stacked on top of, e.g., fourth element 440 in a similar process with minimal modification to existing manufacture process.

FIG. 5 is a demonstrative illustration of an integrated structure of a four-wavelength WDM device according to yet another embodiment of present invention. Differing from the four-wavelength WDM devices 300 and 400 illustrated in FIGS. 3 and 4, where optical signals of four wavelengths all exit the WDM devices in the same front surfaces, WDM device 500 as being illustrated in FIG. 5 may be made such that optical signals of four wavelengths may exit, respectively, both at the front and back surfaces, which results in using less optical elements. The optical elements may be coated differently from those used in WDM devices 300 and 400.

More specifically, WDM device 500 in FIG. 5 has a first, a second, and a third element (base) 510, 520, and 530 bonded together at their respective top and/or bottom surfaces thereby forming a four-wavelength WDM device. For example, a first top surface of first element (base) 510 may be bonded together with a second bottom surface of second element (base) 520, a second top surface of second element (base) 520 may be bonded together with a third bottom surface of third element (base) 530. First left surface 511 and first right surface 512 of first element 510 may be coated similar to those of first element 310 of WDM device 300 in FIG. 3 to allow a WDM optical signal entering first element 510 and a first optical signal of the WDM optical signal, of a first wavelength, exiting WDM device 500 at first right surface 512. However, second left surface 521 of second element 520 may be coated differently from second left surface 321 of second element 320. Second left surface 521 may be coated with a WDM filtering coating (Coating 2) that is reflective to most of the WDM optical signal except a second optical signal of a second wavelength. Second right surface 522 may be coated with a WDM filtering coating (Coating 3) that is reflective to most of the WDM optical signal except a third optical signal of a third wavelength. Third left surface 531 of third element 530 may be coated with a WDM filtering coating (Coating 4) that is reflective to most of the WDM optical signal except a fourth optical signal of a fourth wavelength. Finally, third right surface 532 of third element 530 may be coated or not be coated at all since no optical signal is expected to exit third right surface 532 of third element 530, as being described below in more details.

During operation, a WDM optical signal having at least a first, a second, a third and a fourth wavelengths may enter first left surface 511 of first element 510. Passing through first element 510 and upon incident thereupon, first right surface 512 of first element 510 may reflect most of the WDM optical signal back toward second left surface 521 of second element 520, via an interface between the first and second elements 510 and 520, except for a first optical signal of a first wavelength which may exit WDM device 500 via first right surface 512. Upon incident thereupon, second left surface 521 may reflect most of the remaining WDM optical signal back toward second right surface 522 of second element 520, except for a second optical signal of a second wavelength which may exit WDM device 500 via second left surface 521. Similarly, passing through second element 520 and upon incident thereupon, second right surface 522 of second element 520 may reflect most of the remaining WDM optical signal back toward third left surface 531 of third element 530, via an interface between the second and third elements 520 and 530, except for a third optical signal of a third wavelength which may exit WDM device 500 via second right surface 522. Upon incident thereupon, third left surface 531 of third element 530 may let any remaining WDM optical signal, that is, a fourth optical signal of a fourth wavelength, exit WDM device 500 via third left surface 531. In this particular embodiment, no optical signals are reflected back toward third right surface 532.

In one embodiment where only four wavelengths of optical signals were launched into WDM device 500, third left surface 531 of third element 530, where the last remaining optical signal exits WDM device 500, may not need to be coated with a WDM filtering coating and may instead be coated with an anti-reflective coating should it be desired and such coating be more cost effective than a WDM filtering coating. In another embodiment, third right surface 532 of third element 530 may not be coated at all since all remaining optical signal or lights have exited WDM device 500 before reaching third right surface 532. In one embodiment where there may still be optical signal or lights being reflected back from third left surface 531 toward third right surface 532, such as when a WDM optical signal of more than four designated wavelengths are launched into WDM device 500, third right surface 532 may optionally be coated with an AR coating to allow all incident lights exit, or optionally coated with a light absorbing material to reduce possible reflection of light back into WDM device 500 which may cause undesirable interference to other existing channels of optical signals of different wavelengths.

FIG. 6 is a demonstrative illustration of an integrated structure of a four-wavelength WDM device according to a further embodiment of present invention. Similar to WDM device 500 illustrated in FIG. 5, WDM device 600 as being illustrated in FIG. 6 may have a first element 610 and a second element 620 that are similar to first element 510 and second element 520 of WDM device 500. However, WDM device 600 may have a third element 630 in a triangle shape having a third left surface 631 but without a third right surface such as third right surface 532 as is seen in WDM device 500. As being described above in connection with WDM device 500 illustrated in FIG. 5, because all remaining optical signal or lights exit at third left surface 631 of third element 630, having a third right surface of third element 630, like third right surface 532 of WDM device 500, serves no purpose and thus may be eliminated. In a further embodiment, a first left surface like first left surface 511 of WDM device 500 may also be eliminated so that first element 610 may have a triangle shape.

FIG. 7 is a demonstrative illustration of an integrated structure of an eight-wavelength WDM device according to an embodiment of present invention. Configured similarly to the four-wavelength WDM device 500 illustrated in FIG. 5, an eight-wavelength WDM device 700 may be constructed or configured by stacking five (5) optical elements (710, 720, 730, 740, and 750) together in a fashion similar to that illustrated in FIG. 5 such that four optical signals of four different wavelengths (Lambda 1, Lambda 3, Lambda 5, Lambda 7) may exit WDM device 700 from front surfaces separately, while another four optical signals of four different wavelengths (Lambda 2, Lambda 4, Lambda 6, Lambda 8) may exit WDM device 700 from back surfaces.

Compared with WDM device 500, WDM device 700 is able to handle four additional wavelengths of optical signals by employing two additional optical elements (e.g., 740 and 750). Alternatively, an eight-wavelength WDM devices may be configured in a structure similar to WDM device 400 illustrated in FIG. 4, in which case a total eight (8) optical elements, instead of five (5) as being illustrated in FIG. 7, may be stacked together to handle all eight optical signals of different wavelengths. All of the optical signals may exit the WDM device from its front surfaces. Furthermore, a combination of above two different configuration may be used as well.

In all of the above embodiments, according to embodiments of present invention, optical signals exiting the WDM devices, via it left and/or right surfaces, may be collected via optical coupling for further signal processing. For example, the optical signals may be guided into an optical fiber or being directly detected by an optical detector. In embodiments where the WDM device is used as a WDM multiplexer or signal combiner, optical signals of various wavelengths may be launched and/or coupled into the WDM device directly from a laser source, via a fiber, and/or via optical coupling arrangement in a direction opposite to what is described above.

According to embodiments of present invention, WDM devices including but not limited to those being demonstratively illustrated above in FIG. 2 to FIG. 7, may be manufactured in a faster, reliably, and mass-production way. In short, and more specifically, multiple filtering or filter-base sheet elements may first be manufactured. The filter-base sheet elements may subsequently be bonded together by using epoxy or adhesive agent or through an optical contact bonding process to form an optical assembly block or bulk. The selection of filter-base sheet elements and the number of such sheet elements may depend on the type of wavelengths and number of wavelengths that are designed to be handed by these WDM devices. Finally, the optical assembly block of a stack of multiple filter-base sheet elements may be sliced along its length into multiple WDM devices, as being described below in more details.

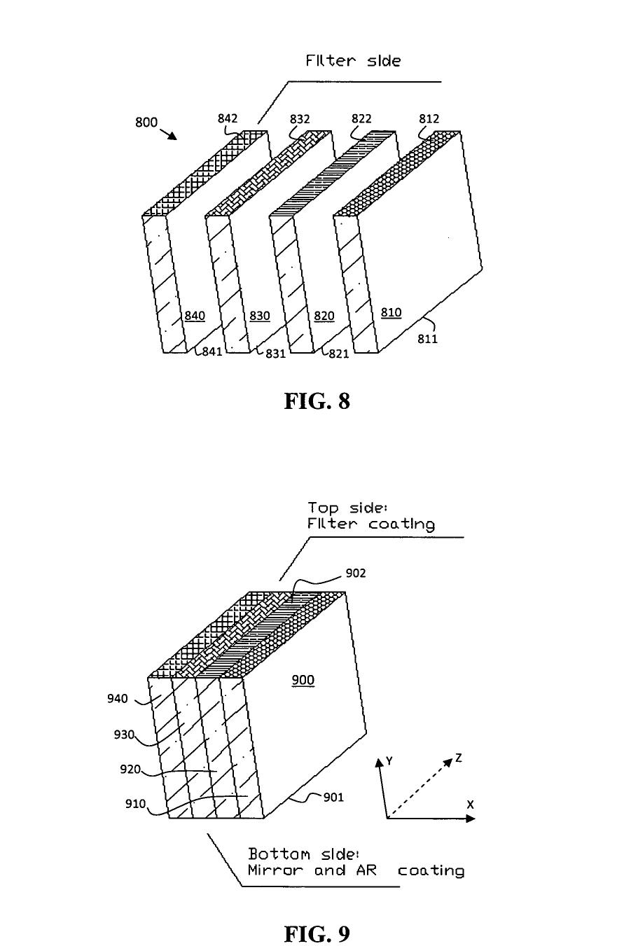

FIG. 8 is a demonstrative illustration of examples of optical filter-base sheet elements according to embodiments of present invention. Each optical filter-base sheet element, such as sheet element 810, 820, 830, and 840 for example, may be coated differently at the bottom surfaces of 811, 821, 831, and 841 and top surfaces of 812, 822, 832, and 843 to be able to work as different optical filters to pass through and/or reflect optical signals of different wavelengths. More specifically, each of sheet elements may be coated, either on one or both of bottom and top surfaces, to work as a filter for one wavelength (for making devices similar to WDM devices 200, 300, and 400) or for two wavelengths (for making devices similar to WDM devices 500, 600, and 700). For example, top surface 812 of sheet element 810 may be coated with a WDM filtering coating such that a first wavelength of optical signal may exit top surface 812 which may reflect optical signals of different wavelengths. Further for example, top surface 822 of sheet element 820 may be coated with a different WDM filtering coating such that a second wavelength of optical signal may exit top surface 822 while bottom surface 821 may be coated with an HR coating that reflects all of incident optical signals. In one embodiment, bottom and top surfaces 821 and 822 of sheet element 820 may be coated with different WDM filtering coatings such that a second wavelength of optical signal may exit bottom surface 821 while a third wavelength of optical signal may exit top surface 822. When being designed as a first sheet element to work as input port for all input optical signals, bottom surface 811 of sheet element 810 may be coated with an AR coating such as to allow most of incident optical signals enter into sheet element 810 with minimal optical power loss. In general, different sheet elements may be coated differently, based on design, to work for different wavelengths.

FIG. 9 is a demonstrative illustration of an example of optical assembly block made of the optical filter-base sheet elements illustrated in FIG. 8. The x-y-z axis are illustrated for the ease of description. Different filter-base sheet elements, as being prepared at step illustrated in FIG. 8, may subsequently be stacked together or bonded together using epoxy, adhesive agent, or optical contact bonding process to form an optical assembly block 900. In one embodiment, top surfaces 812, 822, 832, and 842 may be aligned to be substantially coplanar to each other, and /or bottom surfaces 811, 821, 831, and 841 may be aligned to be substantially coplanar to each other. Optical assembly block 900 includes a stack of multiple sheet elements 910, 920, 930, and 940 along the x-direction and may have a sufficient length along the z-direction to be sliced into multiple pieces of individual WDM devices later.

Optical assembly block 900 has a bottom surface 901 and a top surface 902 and an optical signal generally propagates along a path, back and forth, between the bottom and top surfaces along the y-direction. Depending upon the number of wavelengths to be handled by the WDM device under manufacture and the specific values of individual wavelengths, the corresponding number of sheet elements, with proper WDM filtering coatings, AR coatings, and/or HR coatings, may be rightfully selected. The sheet elements may then be bonded together to form optical assembly block 900. The individual filter-base sheet elements may be prepared and bonded, in such a way and needed precision, as to allow a WDM optical signal incident upon the bottom surface of first sheet element, e.g., sheet element 910, to follow an optical path that goes sequentially through each of the sheet elements, following reflections from top and bottom surfaces of each thereof, as being demonstratively illustrated and described above in connection with WDM devices shown in FIG. 2 to FIG. 7.

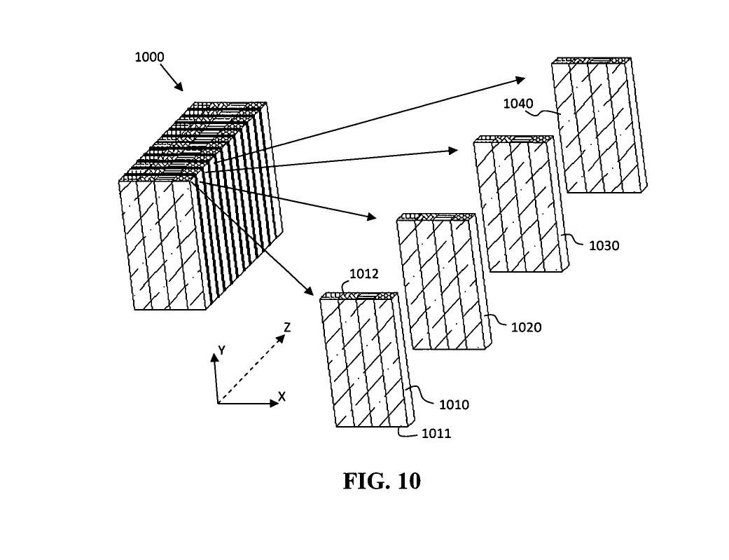

FIG. 10 is a demonstrative illustration of an example of a plurality of WDM devices made from the optical assembly block illustrated in FIG. 9. Optical assembly block 1000 formed in a previous step, such as that in FIG. 9, may subsequently be sliced along its length-direction, such as z-direction in FIG. 10, according to design to create a plurality of WDM devices 1010, 1020, 1030, and 1040 that are functionally identical and have a desired thickness. Each of the WDM devices, such as WDM device 1010, contains a small piece of each filter-base sheet elements (as being described in FIG. 8) that are stacked together and may have a bottom surface 1011 and a top surface 1012, between which a WDM optical signal may propagate back and forth and get filtered and/or reflected. The slicing process may be carried out by mechanical dicing machines or high power optical lasers. Any other existing or future developed techniques may be used to cut or slice optical assembly block 1000.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A WDM (wavelength division multiplexing) device comprising:
a first element having a first right surface and a first top surface; and
a second element having a second left surface and a second bottom surface,
wherein said second bottom surface of said second element is bonded together with said first top surface of said first element and said first right surface of said first element is coated with a WDM filtering coating, and
wherein said WDM filtering coating of said first right surface is adapted to, upon incident of an optical signal having at least a first wavelength and one or more of a second, a third, and a fourth wavelength, cause said first wavelength of said optical signal to exit said first element at said first right surface, and cause rest of said optical signal to be reflected back into said first element, pass through said first top surface of said first element and said second bottom surface of said second element, and enter said second element.

2. The WDM device of claim 1, wherein said second element further comprises a second right surface coated with a WDM filtering coating, said WDM filtering coating of said second right surface is adapted to, upon incident of said optical signal, cause said third wavelength of said optical signal to exit said second element at said second right surface.

3. The WDM device of claim 2, further comprising a third element having a third left surface and a third bottom surface, wherein said second element further comprises a second top surface, wherein said third bottom surface of said third element is bonded together with said second top surface of said second element, and wherein said WDM filtering coating of said second right surface is further adapted to cause rest of said optical signal to be reflected back into said second element, pass through said second top surface of said second element and said third bottom surface of said third element, and enter said third element.

4. The WDM device of claim 3, wherein said third left surface of said third element is coated with a WDM filtering coating, said WDM filtering coating of said third left surface is adapted to, upon incident of said optical signal, cause said fourth wavelength of said optical signal to exit said third element at said third left surface.

5. The WDM device of claim 1, wherein said second left surface of said second element is coated with a WDM filtering coating, said WDM filtering coating of said second left surface is adapted to, upon incident of said optical signal, cause said second wavelength of said optical signal to exit said second element at said second left surface.

6. The WDM device of claim 1, wherein said first element further comprises a first left surface coated with an anti-reflective coating; wherein said optical signal enters said first element at said first left surface; and wherein said second element is bonded together with said first element through an adhesive agent or an optical contact bonding process.

7. A WDM (wavelength division multiplexing) device comprising:
a first element having a first left surface, a first right surface, a first top surface, and a first bottom surface; wherein said first top surface and said first bottom surface are substantially planar and extending from said first left surface to said first right surface; and
a second element having a second left surface, a second right surface, a second top surface, and a second bottom surface, wherein said second top surface and said second bottom surface are substantially planar and extending from said second left surface to said second right surface,
wherein said second bottom surface of said second element is bonded together with said first top surface of said first element; wherein said first right surface of said first element is coated with a first WDM filtering coating; and wherein said second right surface of said second element is coated with a second WDM filtering coating.

8. The WDM device of claim 7, wherein said first left surface of said first element is coated with an anti-reflective coating and upon incident thereupon an optical signal having at least a first and a second wavelength enters said first element, and wherein said first WDM filtering coating of said first right surface is adapted to cause said first wavelength of said optical signal to exit said first element at said first right surface and cause rest of said optical signal to be reflected back to enter said second element through said first top surface of said first element and said second bottom surface of said second element.

9. The WDM device of claim 8, wherein said second left surface of said second element is coated with an high-reflection coating and upon incident of said optical signal, said second wavelength of said optical signal is reflected back by said high-reflection coating of said second left surface to propagate towards said second right surface of said second element, and wherein said second WDM filtering coating of said second right surface is adapted to cause said second wavelength of said optical signal to exit said second element at said second right surface.

10. The WDM device of claim 7, wherein said first and second left surfaces are substantially coplanar and wherein said first and second right surfaces are substantially coplanar.

11. The WDM device of claim 7, wherein said first and second elements are bonded together through an adhesive agent or an optical contact bonding process.

12. The WDM device of claim 7, further comprising a third element having a third left surface, a third right surface, a third top surfacc, and a third bottom surface; wherein said third top surface and said third bottom surface are substantially planar and extending from said third left surface to said third right surface, and wherein said third bottom surface of said third element is bonded together with said second top surface of said second element.

13. The WDM device of claim 12, wherein said second top surface is substantially parallel to said second bottom surface.

14.-20. (canceled)

21. An optical device comprising:
a first element having a first right surface and a first top surface; and
a second element having a second left surface and a second bottom surface,
wherein said second bottom surface of said second element and said first top surface of said first element are substantially parallel to each other and in contact with each other, and
wherein said first right surface of said first element is coated with a WDM filtering coating that is adapted to, upon incident of an optical signal of multiple wavelengths from inside said first element, cause a first wavelength of said optical signal to exit said first element at said first right surface and rest of said optical signal to reflect back into said first element, pass through the optical contact bonding between said first element and said second element, and enter said second element.

22. The optical device of claim 21, wherein said second element further comprises a second right surface coated with a WDM filtering coating, said WDM filtering coating of said second right surface is adapted to, upon incident of said optical signal, cause a second wavelength of said optical signal to exit said second element at said second right surface.

23. The optical device of claim 22, further comprising a third element having a third left surface and a third bottom surface, wherein said second element further comprises a second top surface, wherein said third bottom surface of said third element is in contact with said second top surface of said second element, and wherein said WDM filtering coating of said second right surface is further adapted to cause rest of said optical signal to be reflected back into said second element, pass through said second top surface of said second element and said third bottom surface of said third element, and enter said third element.

24. The optical device of claim 23, wherein said second top surface of said second element is nonparallel with said second bottom surface of said second element.

25. The optical device of claim 23, wherein said third left surface of said third element is coated with a high reflection (HR) coating, said HR coating of said third left surface is adapted to, upon incident of said optical signal, cause said optical signal to be reflected back into said third element.

26. The optical device of claim 21, wherein said second left surface of said second element is coated with a high reflection (HR) coating, said HR coating of said second left surface is adapted to, upon incident of said optical signal, cause said optical signal to be reflected back into said second element.

27. The optical device of claim 21, wherein said first right surface of said first element is substantially perpendicular to said first top surface of said first element, and said second left surface of said second element is substantially perpendicular to said second bottom surface of said second element.
